(19) United States
(12) Patent Application Publication
(10) Pub. No.: US 2006/0237043 A1
(43) Pub. Date: Oct. 26, 2006

(54) Method and apparatus for cleaning semiconductor substrates

(75) Inventors: Steven Verhaverbeke, San Francisco, CA (US); Roman Gouk, San Jose, CA (US)

Correspondence Address: PATENT COUNSEL;APPLIED MATERIALS, INC., Legal Affairs Department, P.O. BOX 450A, Santa Clara, CA, 95052, US

(73) Assignee: Applied Materials, Inc.

(21) Appl. No.: 11/114,276

(22) Filed: Apr. 25, 2005

(51) Int. Cl. B08B 3/02

(52) U.S. Cl. 134/25.4; 134/32; 134/34; 134/36; 134/902; 134/198; 134/184; 134/100.1; 134/103.2; 134/102.1

(57) ABSTRACT

According to one aspect of the present invention, a method and apparatus for cleaning a semiconductor substrate are provided. The apparatus may include a chamber wall defining a processing chamber having a chamber gas therein, a semiconductor substrate support, and a fluid nozzle within the processing chamber having first and second pieces. The first piece may have a tip with a tip opening, and the second piece may have inlet and outlet openings and a fluid passageway therethrough interconnecting the inlet and outlet openings. A space may be defined in the fluid nozzle such that when a semiconductor substrate processing fluid is directed into the fluid passageway a relative low pressure region being formed within the fluid passageway to draw the chamber gas into the fluid passageway through the space between in the fluid nozzle, mix with semiconductor substrate processing fluid, and flow onto the semiconductor substrate.

### BACKGROUND OF THE INVENTION

1). Field of the Invention

This invention relates to a method and apparatus for processing semiconductor substrates. More particularly, this invention relates to a method and apparatus for cleaning semiconductor substrates.

2). Discussion of Related Art

Integrated circuits are formed on semiconductor wafers. The wafers are then sawed (or “singulated” or “diced”) into microelectronic dice, also known as semiconductor chips, with each chip carrying a respective integrated circuit. Each semiconductor chip is then mounted to a package, or carrier, substrate. The packages are often mounted to a circuit board, which may be installed in a computer.

Numerous steps may be involved in the creation of the integrated circuits, such as the formation and etching of various semiconducting, insulating, and conducting layers. During the manufacturing of the integrated circuits, the surfaces of the wafer may have to be cleaned at various times before the formation of the formation of the integrated circuits can be completed. One common method for cleaning the wafers is referred to as “spin cleaning.”

Spin cleaning involves dispensing a chemical cleaning solution onto the wafer and spinning the wafer to remove the solution. In order to increase the effectiveness of the spin clean, sometimes a second dispense head is used to direct a mixture of a gas, such as nitrogen, and an atomized liquid, such as water, over the wafer while the cleaning solution passes over the wafer. Typically, the second dispense heads have diameters of about 3 mm. Using this method, it is the physical force of the gas/liquid mixture striking the wafer that increases the effectiveness of the cleaning.

The fabrication factories in which the wafers are processed often use a single, large pressurized gas supply (e.g., a “house” gas supply) for the entire factory. The maximum flow rate from an output of the gas supply is typically around 100 standard liters per minute (SLPM). When combined with the 3 mm nozzle diameter, the speed of the gas/liquid mixture striking the wafer is around 300 m/s. Such a high speed can damage the more delicate features on the wafer.

Recently, in order to slow the gas/liquid mixture and prevent damage to the wafer, nozzles larger than 3 mm have been used. However, as the diameter of the nozzle increases, the flow rate through the nozzle increases exponentially. As a result, the factory gas supply is not able to provide a sufficient flow rate of gas to maintain a gas/liquid mixture speed that is ideal for cleaning wafers, such as between 60 and 70 m/s.

### SUMMARY OF THE INVENTION

The invention provides a method and apparatus for cleaning a semiconductor substrate. The apparatus may include a chamber wall defining a processing chamber having a chamber gas therein, a semiconductor substrate support within the processing chamber to support a semiconductor substrate, and a fluid nozzle within the processing chamber having first and second pieces. The first piece may have a tip with a tip opening, and the second piece may have inlet and outlet openings and a fluid passageway therethrough interconnecting the inlet and outlet openings. A space may be defined in the fluid nozzle such that when a semiconductor substrate processing fluid is directed from the tip opening into the fluid passageway, from the outlet opening, and onto a semiconductor substrate on the semiconductor substrate support, a relative low pressure region being formed within the fluid passageway to draw the chamber gas into the fluid passageway through the space between in the fluid nozzle, mix with semiconductor substrate processing fluid, and flow onto the semiconductor substrate.

### BRIEF DESCRIPTION OF THE DRAWINGS

The invention is described by way of example with reference to the accompanying drawings wherein:

FIG. 1 is a cross-sectional schematic view of a semiconductor substrate processing system, including a spin clean chamber;

FIG. 2 is a cross-sectional side view of a substrate support assembly within the spin clean chamber illustrated in FIG. 1;

FIGS. 3 and 4 are cross-sectional side views of a nozzle assembly within the spin clean chamber illustrated in FIG. 1;

FIG. 5 is a cross-sectional view on 5-5 in FIG. 3 of the nozzle assembly illustrated in FIG. 3;

FIG. 6A is a cross-sectional schematic view of the semiconductor substrate processing system similar to FIG. 1;

FIG. 6B is a cross-sectional view of the substrate support assembly with a semiconductor substrate thereon;

FIG. 6C is a cross-sectional schematic view of the semiconductor substrate processing system illustrating a cleaning of a top surface of the semiconductor substrate;

FIG. 6D is a cross-sectional side view of the nozzle assembly similar to FIG. 4; and

FIGS. 7A and 7B are top planned views of the semiconductor substrate illustrating the cleaning process shown in FIG. 6C.

### DETAILED DESCRIPTION OF THE INVENTION

In the following description, various aspects of the present invention will be described and various details will be set forth in order to provide a thorough understanding of the present invention. However, it will be apparent to those skilled in the art that the present invention may be practiced with only some or all of the aspects of the present invention, and the present invention maybe practiced without the specific details. In other instances, well-known features are admitted or simplified in order not to obscure the present invention.

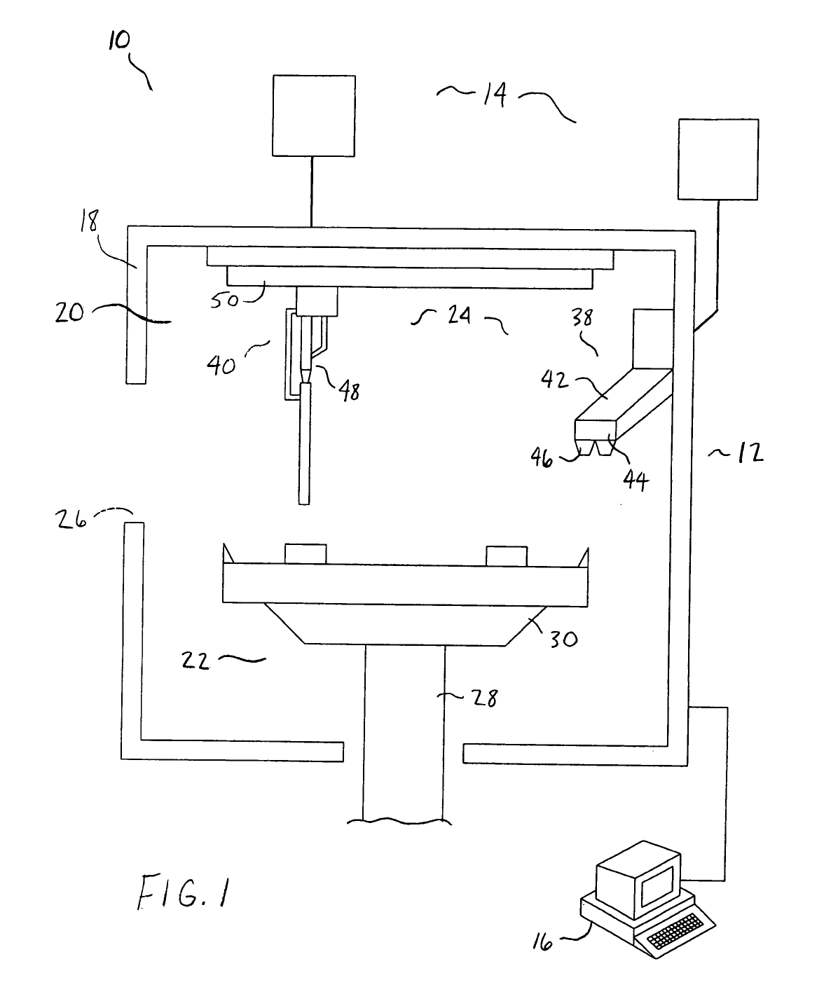

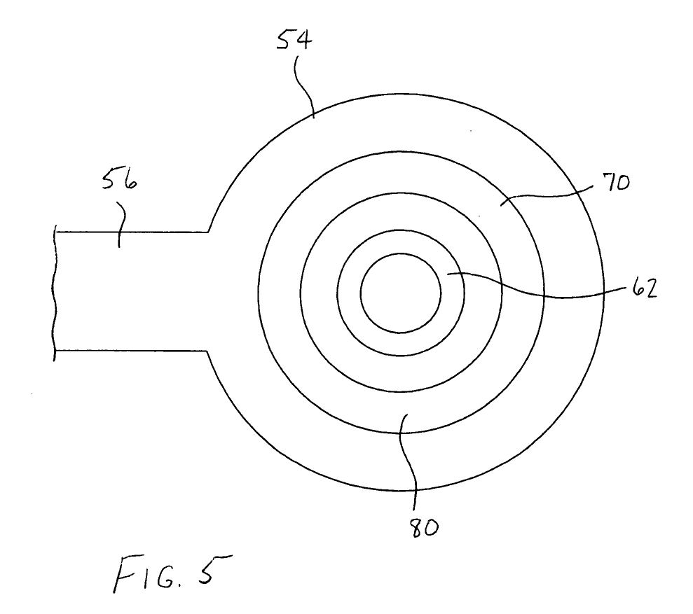

It should be understood the FIGS. 1 through 7B are merely illustrative and may not be drawn to scale.

FIG. 1 to FIG. 7B illustrate a method and apparatus for cleaning a semiconductor substrate. The apparatus may include a chamber wall defining a processing chamber having a chamber gas therein, a semiconductor substrate support within the processing chamber to support a semiconductor substrate, and a fluid nozzle within the processing chamber having first and second pieces. The first piece may have a tip with a tip opening, and the second piece may have inlet and outlet openings and a fluid passageway therethrough interconnecting the inlet and outlet openings. A space may be defined in the fluid nozzle such that when a semiconductor substrate processing fluid is directed from the tip opening into the fluid passageway, from the outlet opening, and onto a semiconductor substrate on the semiconductor substrate support, a relative low pressure region being formed within the fluid passageway to draw the chamber gas into the fluid passageway through the space between in the fluid nozzle, mix with semiconductor substrate processing fluid, and flow onto the semiconductor substrate.

FIG. 1 illustrates a semiconductor substrate processing system 10, according to one embodiment of the present invention. The system 10 may include a spin clean chamber 12, a fluid supply sub-system 14, and a computer control console 16. The spin clean chamber 12 may include a frame or chamber wall 18, enclosing a processing chamber 20, a substrate support assembly 22, and a fluid dispense subsystem 24.

The frame or chamber wall 18 may be, in cross-section, substantially square with a substrate slit 26 in one side thereof. The substrate support assembly 22 may lie within the processing chamber 20 at a lower portion thereof and at a height lower than the substrate slit 26. The substrate support assembly 22 may include a substrate support axel 28 and a substrate support 30. The substrate support axel may vertically extend through a lower piece of the chamber wall, and although not illustrated in detail, may be attached to the frame 18. The substrate support 30 may be attached to an upper end of the substrate support axel 28. The substrate support axel 28 may be able to rotate the substrate support 30 about a central axis thereof at various rates between, for example, 1 revolution per minute (rpm) and 3000 rpm.

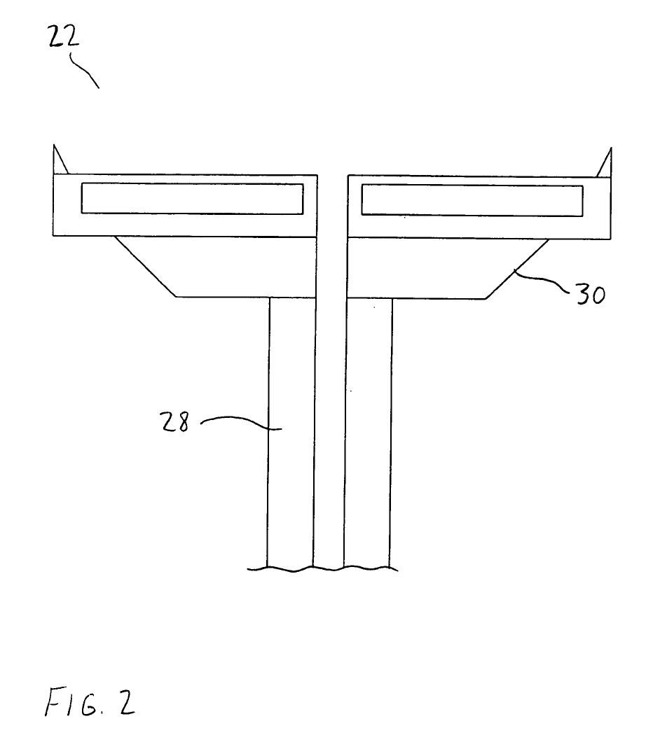

FIG. 2 illustrates the substrate support assembly 22 in greater detail. The substrate support 30 may include support members 32 which extend upwards from an outer edge of the substrate support 30 and transducers 34 which may be embedded in the substrate support 30. A substrate support liquid channel 36 may run vertically through a central portion of the substrate support 30 and the substrate support axel 28. Although not illustrated in detail, it should be understood that the substrate support liquid channel 36 may be connected to the fluid supply subsystem 14.

Referring again to FIG. 1, the fluid dispense subsystem 24 may include a primary fluid dispense mechanism 38 and a secondary fluid dispense mechanism 40. The primary fluid dispense mechanism 38 may be attached to an upper portion of a side piece of the chamber wall 18 opposite the substrate slit 26. The primary fluid dispense mechanism may include a dispense arm 42 and a dispense head 44. The dispense head 44 may be attached to an end of the dispense arm 42 and may include nozzles 46. The dispense arm 42 may be rotatably connected to the chamber wall 18 to move the dispense head 44 back and forth between a position where the dispense head 44 is not positioned over the substrate support 30 and a position where the dispense head 44 is suspended over the substrate support 30. Although not illustrated in detail, it should be understood that the nozzles 46 may also be connected to the fluid supply subsystem 14.

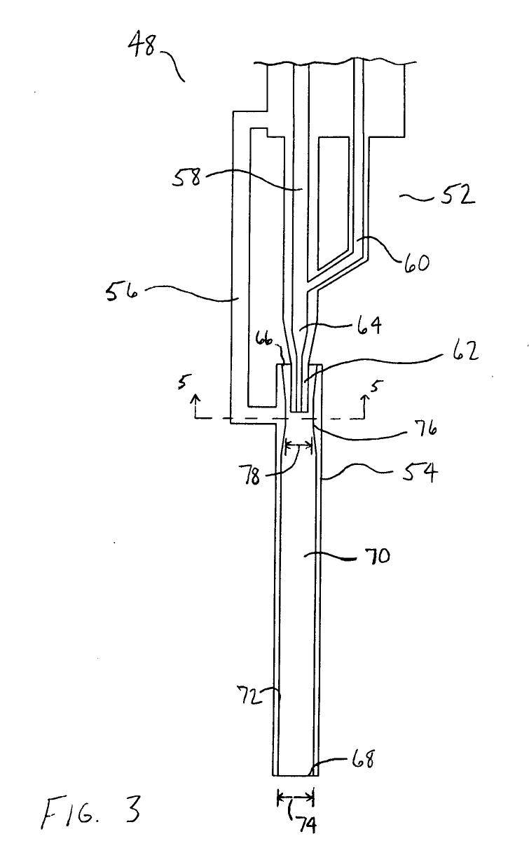

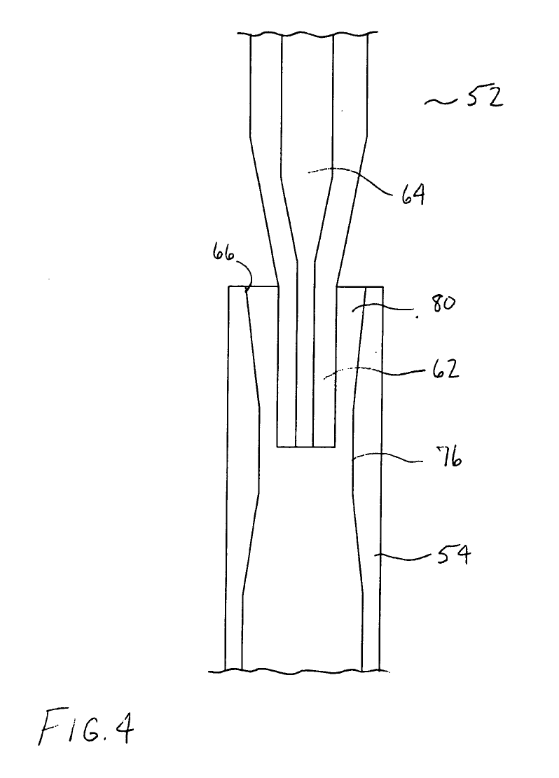

Referring now to FIG. 1 in combination with FIG. 3, the secondary fluid dispense mechanism 40 may include a nozzle assembly 48 and a track 50. The track 50 may be connected to an upper portion of the chamber wall 18, and the nozzle assembly 48 may be movably connected to the track 50 so that the nozzle assembly 48 may slide between opposing ends of the substrate support 30. Referring specifically to FIG. 3, the nozzle assembly 48 may include a first nozzle piece 52, a second nozzle piece 54, and a support member 56. The first nozzle piece 52 may include first 58 and second 60 passageways extending therethrough and a tip, having an opening, at a lower end thereof. The first nozzle piece 52 may also include a mixing, or atomizing, chamber 64 that interconnects the opening in the tip 62, the first passageway 58 and the second passageway 60. As illustrated in FIGS. 3 and 4, the first nozzle piece 52 may have a tapered shape so that the tip 62 has a width less than the remainder of the first nozzle piece 52. Although not illustrated in detail, it should be understood that the first 58 and second 60 passageways may be connected to the fluid supply subsystem 14.

Referring to FIGS. 3, 4, and 5, the second nozzle piece 54 may be cylindrical in shape, and be proportioned such that a height of the second nozzle piece 54 is a multiple of a diameter of the second nozzle piece 54. The second nozzle piece 54 may include an inlet opening 66 at an upper end thereof, an outlet opening 68 at a lower end thereof, and a fluid passageway 70 interconnecting the inlet 66 and outlet 68 openings. The fluid passageway 70 may have an inner surface with a convex shape so that the inner surface includes a first portion 72 with a diameter 74 of, for example, greater than 6 mm, and a second portion 76 with a diameter 78 of, for example, of less than 6 mm. In an embodiment, the diameter 74 of the first portion 72 may be between 6 and 11 mm, and the diameter 78 of the second portion 76 may be between 4 and 9 mm.

The support member 56 may interconnect the first nozzle piece and the second nozzle piece 54 and suspend the second nozzle piece 54 in a position such that the tip 62 of the first nozzle piece 52 is inserted into the inlet opening 66 of the second nozzle piece 54 and lies between opposing surfaces of the second portion 76 of the inner surface of the second nozzle piece 54. There may be a space, or gap 80, in the nozzle assembly 48 which interconnects the fluid passageway 70 and the processing chamber 20. The space 80 may be between the first nozzle piece 52 and the second nozzle piece 54. In an embodiment, the space 80 may completely surround the tip 62 of the second nozzle piece 54.

The fluid supply subsystem 14 may include multiple containers storing various types of semiconductor substrate processing fluids, including gasses and liquids. As previously discussed, the fluid supply subsystem 14 may be connected to the primary fluid dispense mechanism 38, the secondary fluid dispense system 40 and the substrate support mechanism 22. Although not illustrated in detail, it should be understood that the fluid supply subsystem 14 may include a house gas supply which supplies processing gas, such as nitrogen, to the system 10, as well as other semiconductor substrate processing apparatuses within the same factory at the same time. The maximum flow rate from the house gas supply may be 100 standard liters per minute (SLPM).

The computer control console 16 may be in the form of a computer having memory for storing a set of instructions in a processor connected to the memory for executing the instructions, as is commonly understood in the art. The instructions stored with the memory may include a method for cleaning a semiconductor substrate with the system 10 as is described below. The computer control console 16 may be electrically connected to the substrate support assembly 22, the fluid dispense subsystem 24, and the fluid supply subsystem 14.

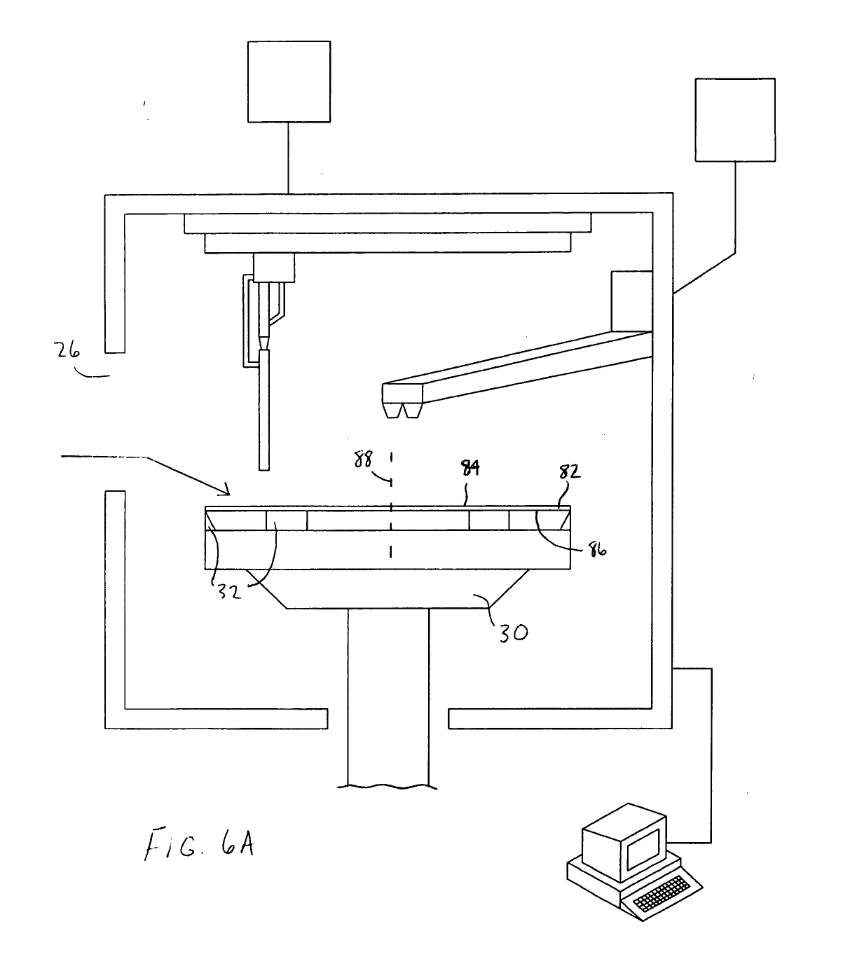

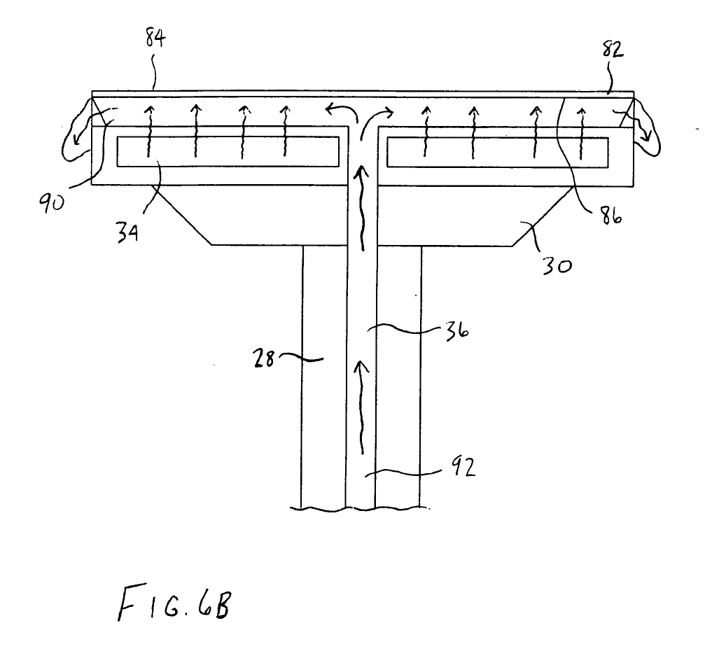

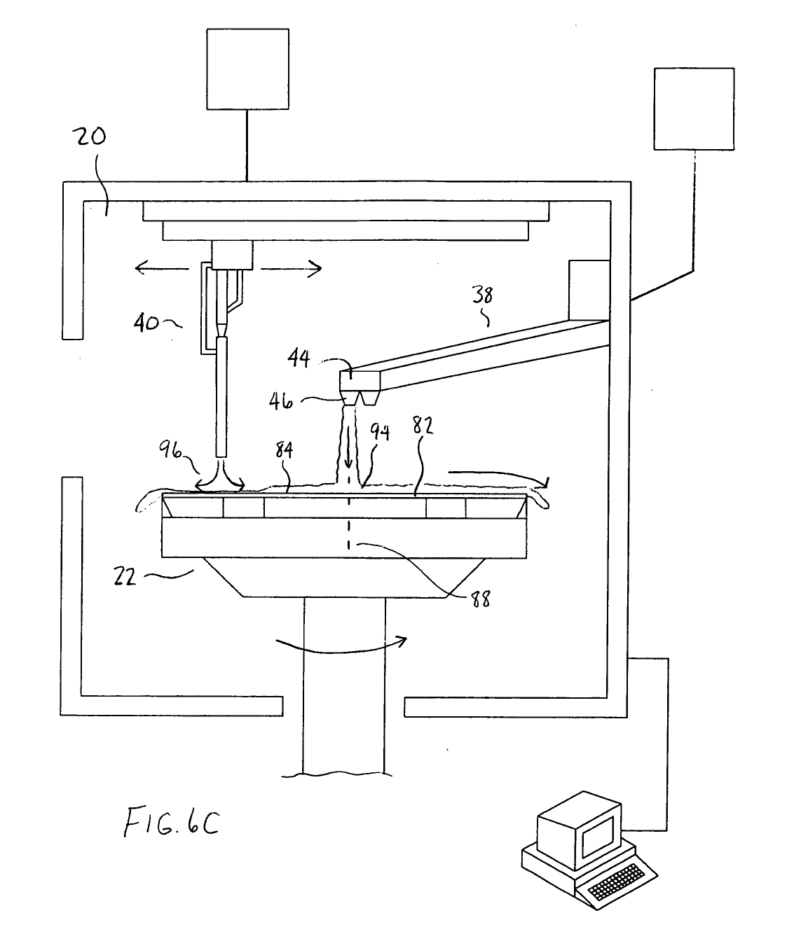

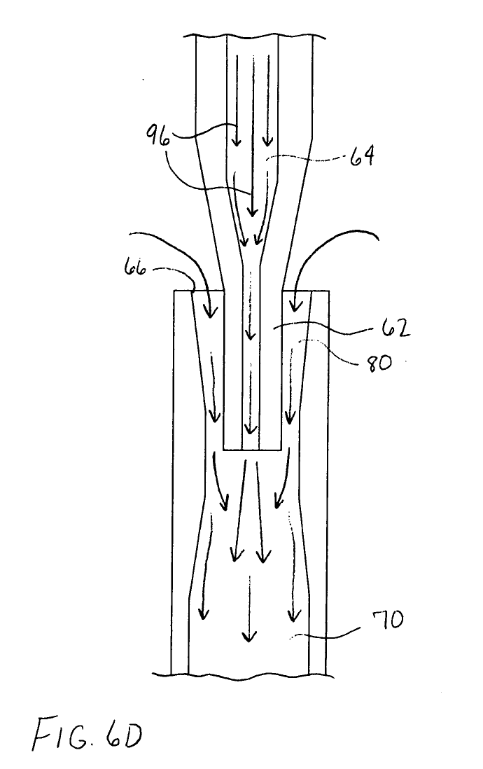

In use, referring to FIG. 6A, a semiconductor substrate 82, such as a semiconductor wafer with a diameter, for example, 200 or 300 mm, may be transported through the substrate slit 26, over the substrate support 30, and directly onto the support members 32. The semiconductor substrate 82 may have an upper surface 84 (or a “device” surface), a lower surface 86 (or a “back-side” or “non-device” surface), and a central axis 88. Although not illustrated in detail, the semiconductor substrate 82 may be “wedged” between the support members 32 so that the central axis 88 is positioned over a central portion of the substrate support 30, and the support members 32 may prevent the semiconductor substrate 82 from moving laterally between edges of the substrate support 30.

As illustrated in FIG. 6B, a gap 90 may lie between the lower surface 86 of the semiconductor substrate 82 and the portion of the substrate support 30 containing the transducers 34. With the upper surface 84 of the semiconductor substrate 82 still being dry, a first semiconductor substrate processing liquid 92 may be injected into the gap 90 beneath the substrate 82 through the substrate support liquid channel 36. The first semiconductor substrate processing liquid 92 may be, for example, a mixture of ammonium hydroxide (NH₄OH) and hydrogen peroxide (H₂O₂), or other suitable cleaning solution. As the first semiconductor substrate processing liquid 92 fills the gap 90, the transducers 34 may be activated to send megasonic energy through the first semiconductor substrate processing liquid 92 to clean the lower surface 86 of the semiconductor substrate 82. Because the upper surface 84 of the semiconductor substrate 82 is substantially dry, the megasonic energy emitted from the transducers 34 may have substantially no effect on the upper surface 84 of the semiconductor substrate 82.

Then, as illustrated in FIG. 6C, the primary fluid dispense mechanism 38 may be activated to position one of the nozzles 46 of the dispense head 44 directly over the central axis 88 of the semiconductor substrate 82. A second semiconductor substrate processing liquid 94 may then be dispensed onto the upper surface 84 of the semiconductor substrate 82 while the substrate support assembly 22 rotates the semiconductor substrate 82 about its central axis 88. The second semiconductor substrate processing liquid 94 may be, for example, a mixture of ammonium hydroxide and hydrogen peroxide, or other suitable cleaning solution. At the same time, the secondary fluid dispense mechanism 40 may direct a semiconductor substrate processing fluid 96 onto a portion of the upper surface 84 of the semiconductor substrate 82.

Referring again to FIG. 3, a semiconductor substrate processing gas may be injected into the mixing chamber 64 through the first passageway 58 of the first nozzle piece 52 while a third semiconductor substrate processing liquid is fed into the mixing chamber 64 through the second passageway 60. The semiconductor substrate processing gas may be, for example, nitrogen, and the third semiconductor substrate processing liquid may be, for example, deionized water. The semiconductor substrate processing gas and the third semiconductor substrate processing liquid may mix in the mixing chamber to form the semiconductor substrate processing fluid which may include the semiconductor substrate processing gas saturated with micro-particles, or atomized particles, of the third semiconductor substrate processing liquid. The semiconductor substrate processing fluid 96 may exit the tip 62 of the first nozzle piece at a maximum flow rate of approximately 100 SLPM.

Referring to FIGS. 6C and 6D, as the semiconductor substrate processing fluid 96 passes through the fluid passageway 70 of the second nozzle piece 54 and onto the semiconductor substrate 82, the gaseous pressure within the fluid passageway 70 may drop below the gaseous pressure present in the processing chamber 20. Thus, a relative low pressure region is formed within the fluid passageway 70. As a result, a processing gas, such as ambient air, within the processing chamber may be drawn into the fluid passageway 70 through the space 80 between the first nozzle piece 52 and second nozzle piece 54 which interconnects the fluid passageway 70 and a processing chamber 20. The processing gas that enters the fluid passageway 70 from the processing chamber 20 may mix with the semiconductor substrate processing fluid 96 and increase the amount of fluid that is directed onto the upper surface 84 of the semiconductor substrate 82. It should be noted that the shape of the inner surface of the fluid passageway 70 may further increase the speed of the fluid flowing therethrough and thus further decrease the gaseous pressure within the fluid passageway.

The amount of fluid flow onto the semiconductor substrate 82 from the outlet opening 68 of the second nozzle piece 54 may be between 500 and 1000 SLPM. The fluid 96 may exit the outlet opening 68 at a speed of, for example, between 60 and 70 m/s.

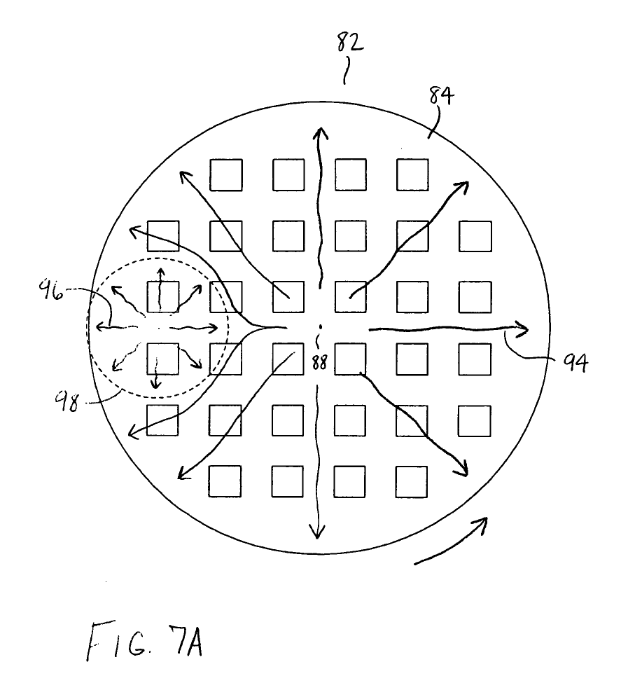

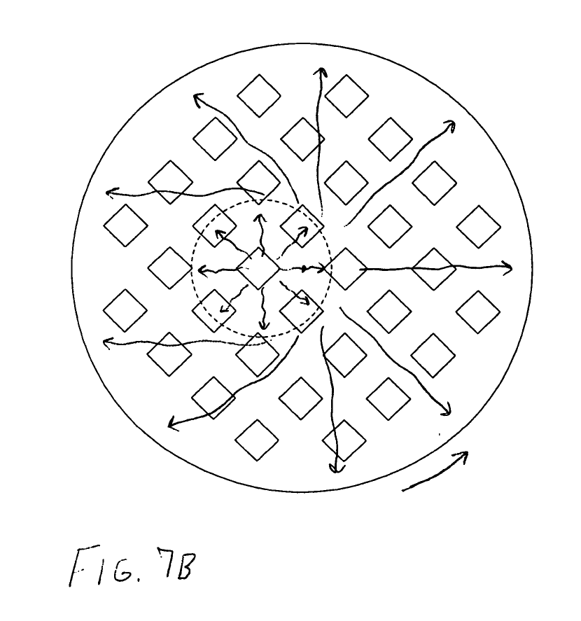

FIGS. 7A and 7B illustrate the upper surface 84 of the semiconductor substrate 82 while both the second semiconductor substrate processing liquid 94 and the semiconductor substrate processing fluid 96 are being flown thereon. As illustrated, the semiconductor substrate processing fluid 96 creates an area of impingement 98 to maximize the cleaning of the upper surface 82 performed by both the second semiconductor substrate processing liquid 94 and the semiconductor substrate processing 96. As the substrate 82 is rotated about its central axis 88, the area of impingement 98 may be moved across a radius of the substrate 82 due to the movement of the nozzle assembly 48 along the track 50.

One advantage is that because of the large diameter of the outlet opening of the nozzle assembly, and the increased flow rate therethrough, the size of the impingement area on the surface of the substrate is increased. As a result, the rate at which the surface of the substrate is cleaned is maximized. Another advantage is that because of the space in the nozzle assembly between the fluid passageway and the processing chamber, the amount of fluid passing through the nozzle is increased, allowing the speed of the fluid exiting the nozzle to remain sufficiently high to effectively clean the surface of the substrate. A further advantage is that quantitative analysis has shown that the larger nozzle, along with the increased flow rate, provides a more effective cleaning method.

Other embodiments may use different methods to increase the amount of fluid flowing though the nozzle, such as having one or more spaces in the nozzle at different locations. A fan, or blower, may also be used in conjunction with the house gas supply to increase the flow rate from the fluid supply subsystem to over 100 SLPM. The space need not completely separate the nozzle into two pieces. Other shapes and sizes of nozzle may also be used, such as an elongated nozzle piece to span the radius, or the diameter, of the substrate so that the nozzle need not be moved during the cleaning process.

While certain exemplary embodiments have been described and shown in the accompanying drawings, it is to be understood that such embodiments are merely illustrative and not restrictive of the current invention, and that this invention is not restricted to the specific constructions and arrangements shown and described since modification may occur to those ordinarily skilled in the art.

What is claimed:

1. A semiconductor substrate processing apparatus comprising:
a chamber wall defining a processing chamber, the processing chamber having a chamber gas therein;
a semiconductor substrate support within the processing chamber to support a semiconductor substrate; and
a fluid nozzle within the processing chamber having first and second pieces, the first piece having a tip with a tip opening, the second piece having inlet and outlet openings and a fluid passageway therethrough interconnecting the inlet and outlet openings, a space being defined in the fluid nozzle such that when a semiconductor substrate processing fluid is directed from the tip opening into the fluid passageway, from the outlet opening, and onto a semiconductor substrate on the semiconductor substrate support, a relative low pressure region being formed within the fluid passageway to draw the chamber gas into the fluid passageway through the space between in the fluid nozzle, mix with semiconductor substrate processing fluid, and flow onto the semiconductor substrate.

2. The apparatus of claim 1, wherein the space is defined between the first and second pieces of the fluid nozzle.

3. The apparatus of claim 2, wherein the tip of the first piece of the fluid nozzle is inserted in the inlet opening of the second piece of the fluid nozzle.

4. The apparatus of claim 3, wherein the first piece of the fluid nozzle further comprises first and second passageways and a mixing chamber interconnecting the first and second passageways and the tip opening.

5. The apparatus of claim 4, wherein the semiconductor substrate processing fluid comprises a semicoductor substrate processing gas and a semiconductor substrate processing liquid.

6. The apparatus of claim 5, wherein the semiconductor substrate processing gas enters the mixing chamber through the first passageway and the semiconductor substrate processing liquid enters the mixing chamber through the second passageway to form the semiconductor substrate processing fluid within the mixing chamber.

7. The apparatus of claim 6, wherein the second piece of the fluid nozzle is cylindrical with an inner width being at least 6 mm.

8. The apparatus of claim 6, wherein the second piece of the fluid nozzle has an inner surface, a first portion of the inner surface having an inner width being at least 6 mm and a second portion of the inner surface having a inner width being less than the first inner width.

9. The apparatus of claim 8, wherein the second piece of the fluid nozzle is positioned such that the tip opening of the first portion of the fluid nozzle is located at the second portion of the inner surface of the second piece of the fluid nozzle.

10. The apparatus of claim 9, wherein the second piece of the fluid nozzle has a circular cross-section when viewed from a central axis thereof.

11. The apparatus of claim 10, wherein the semiconductor substrate support further comprises at least one megasonic transducer to apply megasonic energy to the semiconductor substrate on the semiconductor substrate support.

12. The apparatus of claim 11, further comprising a liquid nozzle to dispense a second semiconductor substrate processing liquid onto the semiconductor substrate.

13. A semiconductor substrate processing system comprising:
a frame;
a chamber wall defining a processing chamber, the processing chamber having a chamber gas therein at a first gaseous pressure;
a semiconductor substrate support connected to the frame and being positioned within the processing chamber to support a semiconductor substrate;
a fluid nozzle connected to the frame and positioned within the processing chamber, the fluid nozzle having first and second pieces, the first piece having a tip with tip opening and a first passageway therethrough connected to the tip opening, the second piece having inlet and outlet openings and a second passageway therethrough interconnecting the inlet and outlet openings and being shaped and positioned so that the tip of the first piece is inserted into the second passageway through the inlet opening of the second piece with a space being defined between at least a portion of the first piece and a portion of the second piece; and
a semiconductor substrate processing fluid supply in fluid communication with the first passageway of the first piece of the fluid nozzle to supply a semiconductor substrate processing fluid to the first passageway such that the semiconductor substrate processing fluid flows from the tip opening, into the second passageway of the second piece, from the outlet opening of the second piece, and onto a semiconductor substrate on the semiconductor substrate support, said flow though the second passageway causing a second gaseous pressure within the second passageway, the second gaseous pressure being less than the first gaseous pressure to draw the processing chamber gas into the second passageway through the space to mix with the semiconductor substrate processing fluid and flow onto the semiconductor substrate.

14. The system of claim 13, wherein the second piece of the fluid nozzle is cylindrical with an inner width being at least 6 mm.

15. The system of claim 13, wherein the second piece of the fluid nozzle has an inner surface, a first portion of the inner surface having an inner width being at least 6 mm and a second portion of the inner surface having an inner width being less than the inner width of the first portion.

16. The system of claim 15, wherein the first piece of the fluid nozzle further comprises first and second fluid inlet passageways and a mixing chamber interconnecting the first and second fluid inlet passageways and the tip opening.

17. The system of claim 16, wherein the semiconductor substrate processing fluid comprises a semiconductor substrate processing gas and a semiconductor substrate processing liquid.

18. The system of claim 17, wherein the semiconductor substrate processing gas enters the mixing chamber through the first fluid inlet passageway and the semiconductor substrate processing liquid enters the mixing chamber through the second fluid inlet passageway to form the semiconductor substrate processing fluid within the mixing chamber.

19. The system of claim 18, wherein the second piece of the fluid nozzle is positioned such that the tip opening of the first piece is located between opposing areas of the second portion of the inner surface of the second piece of the fluid nozzle.

20. The system of claim 19, wherein the second piece of the fluid nozzle has a circular cross-section when viewed along a central axis thereof.

21. The system of claim 20, wherein the semiconductor substrate support further comprises at least one megasonic transducer to apply megasonic energy to the semiconductor substrate on the semiconductor substrate support.

22. The system of the claim 21, further comprising a liquid nozzle connected to the frame to dispense a second semiconductor substrate processing liquid onto the semiconductor substrate.

23. A method of processing a semiconductor substrate comprising:
defining a gap in a fluid nozzle, the fluid nozzle having inlet and outlet openings and a passageway interconnecting the inlet and outlet openings; and
flowing a semiconductor processing fluid through the passageway, from the outlet opening, and onto a first side of a semiconductor substrate, said flowing through the passageway creating a relative low pressure region within the passageway such that ambient gas is drawn through the gap to mix with the semiconductor substrate processing fluid before it flows onto the substrate.

24. The method of claim 23, wherein the semiconductor substrate processing fluid enters the fluid passageway through the inlet opening at a first flow rate and said mixture of the semiconductor substrate processing fluid and the ambient gas exits the outlet opening at a second flow rate, the second flow rate being greater than the first flow rate.

25. The method of claim 24, wherein the semiconductor substrate processing fluid comprises a semiconductor substrate processing gas and a semiconductor substrate processing liquid.

26. The method of claim 25, further comprising dispensing a second semiconductor substrate processing liquid onto the first side of the semiconductor substrate.

27. The method of claim 25, wherein said flowing of the semiconductor substrate processing fluid and said dispensing of the second semiconductor occur simultaneously.

28. The method of claim 26, further comprising flowing a third semiconductor substrate processing liquid onto a second side of the semiconductor substrate.

29. The method of claim 28, further comprising applying megasonic energy to the second side of the semiconductor substrate while the first side of the semiconductor substrate is dry.
